(19) United States
(12) Patent Application Publication
(10) Pub. No.: US 2003/0226005 A1
(43) Pub. Date: Dec. 4, 2003

(54) Bootable CD controller with embedded operating system

(76) Inventors: Vincent Wu, Irvine, CA (US); Sheng Lee, Irvine, CA (US)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/156,521

(22) Filed: May 28, 2002

(51) Int. Cl. G06F 15/177

(52) U.S. Cl. 713/1

(57) ABSTRACT

A printer controller is disclosed which includes one or more non-volatile memory elements for storing print/fax/scan data and printer controller system parameters. The non-volatile memory elements can include flash memory PCMCIA cards. A non-volatile storage medium is also provided for retaining an operating system, wherein the printer controller is bootable from the non-volatile storage medium. The non-volatile storage medium is preferably a CD-ROM or other removable type data disc.

### BACKGROUND OF THE INVENTION

The present invention is directed to the field of booting operating systems, particularly the type used for controllers of output peripheral components, such as network printers. The controllers of such network printers, e.g. models SC-2 and GL-1010, use the Microsoft Embedded NT operating system (OS). In order to perform these software updates, a controller CD-ROM is installed. The CD-ROM is used to boot up the system, after which the updates are made to the OS software on the controller hard drive. After the software update is completed, the user must remove the CD-ROM and reboot the controller from the hard drive. After the controller boots up and begins running, the controller accepts print jobs from a client. The controller can also network with the client to set up system and user parameters, and can store print/scan jobs on the controller hard drive.

In situations where software updates for operating systems can be frequent, the above steps of booting from the CD and rebooting from the hard drive can be cumbersome and time consuming. Also, additional time and effort may often be expended in diagnosing and troubleshooting OS problems after a software update. Also, the hard drive can be unreliable storage medium, vulnerable to computer viruses and other sources of errors or loss of data. Also, the hard drive is an additional component that adds to the size and expense of the controller.

### SUMMARY OF THE INVENTION

The difficulties and drawbacks associated with previous-type systems are overcome by the method and apparatus of the present invention. A printer controller is disclosed which includes one or more non-volatile memory elements for storing print/fax/scan data and printer controller system parameters. The non-volatile memory elements can include flash memory PCMCIA cards. A non-volatile storage medium is also provided for retaining an operating system, wherein the printer controller is bootable from the non-volatile storage medium. The non-volatile storage medium is preferably a CD-ROM or other removable type data disc.

As will be realized, the invention is capable of other and different embodiments and its several details are capable of modifications in various respects, all without departing from the invention. Accordingly, the drawing and description are to be regarded as illustrative and not restrictive.

### BRIEF DESCRIPTION OF THE DRAWINGS

FIG. 1 depicts a bootable CD controller in accordance with the present invention.

### DETAILED DESCRIPTION OF THE INVENTION

In order to simplify the two-step boot operation as mentioned above, the controller of the present invention uses OS and controller code from a non-volatile storage disc, preferably a CD-ROM or DVD-ROM. It utilizes external memory cards (non-volatile flash memory) to store user data and system parameters which would have been stored on hard drive. Since the static object code of the OS and controller resides on a different media than the variable user data and parameters, updating (or upgrading) the OS or Controller becomes extremely trivial. The administrator simply shuts down the system, replaces the CD with a new version, and restarts the system. The data and system parameters remain unchanged across system restart.

In the preferred embodiment, the present bootable CD controller uses an embedded operating system, preferably “Windows NT Embedded” sold by Microsoft Corporation. An embedded OS offers several benefits for this type of implementation. For example, this OS does not require the use of a keyboard, mouse or VGA monitor. Also, selectable modules can be installed on various destination media, including a hard drive, a ROM, and a CD-ROM. An embedded OS is reliable in system shutdown, reboot, and boot up states.

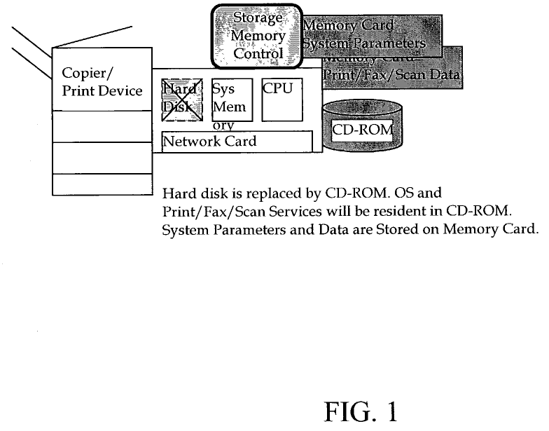

As shown in FIG. 1, a CD-ROM replaces the previous function of the hard drive, and the OS and system services remain with the CD-ROM, thus making it bootable. Storage for system parameters and print/fax/scan data is stored in Flash memory card. Two slots of PCMCIA cards are used, one for system, the other for data. Such data as had previously been stored on the hard drive is now retained in the memory card partitions.

The CD-ROM contains the bootable partition, the Windows NT Embedded Operating System files, the basic NT services, and the device drivers. The CD-ROM also contains the controller service files for “Print,” “Fax,” “Scan” and “Network” functions, along with web page files.

The system parameters are directed to the system memory card. This is preferably accomplished using the embedded OS tool called “Target Designer.” Of course, this can also be accomplished with other similar tools. The system memory card also includes a “Disable Page” file (i.e. a memory swap file) from the embedded OS and Windows NT activities settings (such as network setup parameters). The system memory card can retain other variable data such as a “Print Spooler” temporary file storage and system event logs.

The data is directed to the data memory card, and can include print job data. This print job data is in a file format that encompasses the function of the “job record” that had previously been stored in the NT registry. The data memory card also includes fax job data, scan data and email data, along with any job or message logs.

A “Storage Volume Control” utility program is preferably implemented to monitor memory card storage volume. This utility program includes software settings to limit the usage of partition, to prevent a maximum data limit to be exceeded.

As described herein, the present bootable CD controller provides many benefits, including the phase-out and discontinuation of the hard drive controller model, resulting in reducing the size of the hardware and the cost of distribution. Also, reliability of storage media is improved by replacing the volatile hard drive with a CD-ROM. The bootable CD also provides savings of time and effort for software version upgrades, and OS trouble shooting and diagnostics. The invention also provides virus protection by employing read-only media.

As described hereinabove, the present invention solves many problems associated with previous type systems. However, it will be appreciated that various changes in the details, materials and arrangements of parts which have been herein described and illustrated in order to explain the nature of the invention may be made by those skilled in the area within the principle and scope of the invention will be expressed in the appended claims.

We claim:

1. A printer controller comprising:
at least one non-volatile memory element for storing print/fax/scan data and printer controller system parameters;
a non-volatile storage medium for retaining an operating system, wherein the operating system is bootable from the non-volatile storage medium.

2. The printer controller of claim 1 wherein the non-volatile storage medium is a non-volatile storage disc.

3. The printer controller of claim 2 wherein the non-volatile storage disc is one of a CD-ROM and a DVD-ROM.

4. The printer controller of claim 1 wherein the operating system is an embedded operating system.

5. The printer controller of claim 1 wherein the at least one non-volatile memory element comprises at least one flash memory PCMCIA card.

6. The printer controller of claim 1 wherein the non-volatile storage medium comprises a CD-ROM containing at least one of: a bootable partition; embedded operating system files; device drivers; controller service files for “Print,” “Fax,” “Scan” and “Network” functions; and web page files.

7. The printer controller of claim 1 wherein the non-volatile storage medium comprises a system memory card for storing at least one of: system parameters; a memory swap file from the embedded OS; a print spooler; and a system event log.

8. The printer controller of claim 1 wherein the non-volatile storage medium comprises a data memory card for storing at least one of: print job data; fax job data; scan data; email data; a job log and a message log.

9. The printer controller of claim 1 further comprising a storage volume control utility program to monitor memory card storage volume, to limit the usage of partition, to prevent a maximum data limit from being exceeded.

10. A method comprising:
storing print/fax/scan data and printer controller system parameters on at least one non-volatile memory element;
retaining an operating system on a non-volatile storage medium;
booting the operating system from the non-volatile storage medium.

11. The method of claim 10 wherein the steps of retaining and booting are performed from a non-volatile storage disc.

12. The method of claim 11 wherein steps of retaining and booting are performed from one of a CD-ROM and a DVD-ROM.

13. The method of claim 10 wherein the steps of retaining and booting an operating system comprise retaining and booting an embedded operating system.

14. The method of claim 10 wherein the step of storing on at least one non-volatile memory element comprises storing on at least one flash memory PCMCIA card.

15. The method of claim 10 further comprising an additional step of retaining on the non-volatile storage medium at least one of: a bootable partition; embedded operating system files; device drivers; controller service files for “Print,” “Fax,” “Scan” and “Network” functions; and web page files.

16. The method of claim 10 wherein the step of storing on a non-volatile storage medium comprises storing on a system memory card at least one of: system parameters; a memory swap file from the embedded OS; a print spooler; and a system event log.

17. The method of claim 10 wherein the step of storing on a non-volatile storage medium comprises storing on a data memory card at least one of: print job data; fax job data; scan data; email data; a job log and a message log.

18. The method of claim 10 further comprising a step of monitoring memory card storage volume in order to limit the usage of partition, to prevent a maximum data limit from being exceeded.
